(19) United States
(12) Patent Application Publication
(10) Pub. No.: US 2015/0375663 A1
(43) Pub. Date: Dec. 31, 2015

(54) TRAILER APPARATUSES

(71) Applicant: Fontaine Commercial Trailer, Inc., Haleyville, AL (US)

(72) Inventor: Neil Harrison McNeil Robertson, Lawrenceville, GA (US)

(73) Assignee: Fontaine Commercial Trailer, Inc., Haleyville, AL (US)

(21) Appl. No.: 14/585,879

(22) Filed: Dec. 30, 2014

Related U.S. Application Data
(60) Provisional application No. 62/017,493, filed on Jun. 26, 2014.

(51) Int. Cl. B60P 1/18; B60Q 1/50; B60P 1/04

(52) U.S. Cl. CPC B60P 1/18; B60P 1/04; B60Q 1/50

(57) ABSTRACT

A traveling axle trailer includes an elongated deck being constructed with an underlying frame provided with a set of main support beams and a set of guide beams located between these support beams. The guide beams are configured with rear guiding and supporting surfaces extending in one sloping direction between the front end and the rear end of the trailer. Front guiding and supporting surfaces on the guide beams extend in another sloping direction opposite the one sloping direction between the front end and the rear end of the trailer. An undercarriage is movably supported along the guide beams between a transport position and a loading position. The undercarriage has a frame provided with a set of front guiding and supporting assemblies and a set of rear guiding and supporting assemblies. The rear and front guiding and supporting assemblies are engaged for progressive movement with the rear guiding and supporting surfaces in the one sloping direction and with the front guiding and supporting surfaces in the opposite sloping direction to move the elongated deck from the transport position to the loading position. A translating arrangement is provided for moving the undercarriage along the guide beams.

### CROSS-REFERENCE TO RELATED APPLICATION

The present utility application relates to and claims priority to U.S. Provisional Patent Application No. 62/017,493, filed Jun. 26, 2014, which is incorporated herein in entirety.

### FIELD

The present disclosure relates to trailers for motor vehicles, and in particular, pertains to a tilt, bed traveling or sliding axle trailer which is useful in loading, unloading and transporting heavy objects.

### BACKGROUND

The following U.S. patents and U.S. published application are incorporated herein by reference in entirety:

U.S. Pat. No. 4,125,198 discloses a trailer having a tiltable bed and a wheel supported undercarriage that is supported with structure mounting the undercarriage for reciprocal movement for and aft of the bed between a forward, bed-tilting position and a rearmost, wading position wherein the bed is carried lower to the ground to accommodate higher loads. The mounting structure includes a pair of tracks on the bed and a series of ramps for raising the bed relative to the undercarriage when the latter is shifted from its wading position such that sufficient spacing between the bed and the undercarriage is provided for clearance of the bed under structure during movement of the undercarriage along its fore and aft path of travel.

U.S. Pat. No. 4,231,710 discloses a tiltable trailer that is provided with longitudinal beams that are spaced such as to be located directly beneath the wheels of equipment to be hauled, thereby eliminating the need for heavy crosspieces beneath the deck for the supporting wide loads, and contributing toward decreased trailer weight. A lower deck weight is accomplished by having the tracks for the rollers of the reciprocable undercarriage and the ramps of such tracks located within the beams, by positioning the undercarriage between the beams and by providing the undercarriage with a low-profile beam support which in turn, has roller mounting cross members immediately ahead of and immediately behind the wheel and axle assemblies.

U.S. Pat. No. 5,013,056 discloses a trailer having a tiltable main deck and a shiftable undercarriage that includes an undercarriage assembly having a deck support structure mounted thereon for supporting the deck. The deck support structure includes lifting arms for lifting the elongated deck assembly relative to the undercarriage independently of the undercarriage shifting mechanism so that the deck may be lifted relative to the undercarriage without simultaneously shifting the undercarriage along the deck. The trailer may include a hitch assembly that permits the trailer to be pivotally connected to a towing vehicle to permit the forward deck to he tilted away from the main deck to increase the angle between the main deck and the forward deck when the trailer is in the unloading position. Further, a deck adjustment assembly is disclosed for adjusting the relative positions of the decks.

U.S. Pat. No. 5,211,413 discloses an elongated trailer including a bed supported on an undercarriage, where the undercarriage is shiftable longitudinally between roading and loading positions. At least one beam is provided on the bed and includes a lower flange defining a tracking surface, a web extending, upward from the central longitudinal axis of the flange, and forward and rear ramps formed in the tracking surface. The forward and rear ramps are spaced longitudinally from one another and extend laterally inward from opposite sides of the tracking surface. The ramps are a greater width than one-half the width of the tracking surface so that the ramps overlap one another when viewed along the central longitudinal axis, and each ramp extends beneath the web. A pair of rollers is supported on the undercarriage for rotational movement, bear against the central longitudinal axis of the tracking surface and engage the ramps when the undercarriage is shifted to the roading position.

U.S. Patent Application Publication No. U.S. 2008/0231016 discloses a trailer combined with a movable wheel assembly. The trailer comprises a front portion and a load carrying bed portion. The front portion is combined with the load carrying bed portion at a pivot point so that the front portion and the load carrying bed portion can pivot relative to each other. A rack and pinion means allows selected movement of the Wheel assembly relative to the trailer. The rack is combined with the load carrying bed portion of the trailer, and the pinion is combined with the movable wheel assembly. A power assist means, such as a hydraulic motor, is combined with the movable wheel assembly and is adapted to rotate the pinion. Activation of the power assist means rotates the pinion and moves the wheel assembly in a first direction along the rack towards the front of the load carrying bed or in a second direction along the rack towards the rear of the load carrying bed. As the wheel assembly is moved towards the front of the load carrying bed, the rear end of the load carrying bed can be lowered to the ground to act as a ramp to allow objects to be loaded or unloaded from the trailer.

### SUMMARY

Through research and experimentation, the present inventor has determined that a need exists to design and construct a tilt bed, traveling, axle trailer to better facilitate the safe and efficient loading and unloading of heavy cargo, and to provide enhancements in achieving lower deck height with improved loading and tipping angles. The inventor has found it to be desirable to provide a tilt bed traveling axle trailer with various operating features which will enable better operator accessibility and increased ease of operation.

In one example, the present disclosure relates to a traveling, axle trailer that is movable between a transport position and a loading position. The trailer includes an elongated deck adapted to he connected to a towing vehicle. The elongated deck is constructed with a front end, a rear end and an underlying main frame provided with a pair of main support beams extending longitudinally of the trailer along lateral sides thereof A pair of guide beams extends longitudinally of the trailer between the main support beams. The main frame includes a set of transverse crossbeams interconnecting the main support beams and the guide beams. An undercarriage is movably supported and guided along the guide beams between the transport position and the loading position. A translating arrangement is provided for moving the undercarriage back and forth along the guide beams. The undercarriage includes an undercarriage frame having a plurality of axles provided with ground engaging wheels mounted thereon. The frame includes a pair of longitudinal side members disposed laterally inwardly of the wheels and joined together by a front cross member and a rear cross member. The front cross member includes a set of front guiding and supporting, assemblies located outside the side members of the undercarriage frame and engaged with the guide beams. The side members have outer surfaces including a set of rear guiding and supporting assemblies engaged with the guide beams and spaced forwardly of the rear cross member.

In another example, a traveling axle trailer is supported on a ground surface and is movable from a transport position to a loading position. The trailer includes an elongated deck adapted to be connected to a towing vehicle. The elongated deck is constructed with a front end, a rear end and an underlying main frame provided with a set of main support beams extending longitudinally of the trailer along lateral sides thereof A pair of guide beams extends longitudinally of the trailer between the main support beams. The main frame includes a set of transverse crossbeams interconnecting the main support beams and the guide beams. The guide beams are configured with rear guiding and supporting surfaces extending in one sloping direction between the front end and the rear end of the trailer, Front guiding and supporting surfaces are located forwardly of the rear guiding and supporting surfaces and extend in another sloping direction opposite the one sloping direction between the front end and the rear end of the trailer. An undercarriage is movably supported and guided along the guide beams between the transport position and the loading position. The undercarriage has a frame provided with a set of front guiding and supporting assemblies and a set of rear guiding and supporting assemblies spaced rearwardly of the front guiding and supporting assemblies. The front and rear guiding, and supporting, assemblies are engaged for progressive movement with the rear guiding and supporting surfaces in the one sloping direction and with the front guiding and supporting surfaces in the opposite sloping direction to move the elongated deck from the transport position to the loading position during which movement the elongated deck is tilted such that the rear end of the trailer engages the ground surface. A translating arrangement is provided for moving the undercarriage along the guide beams.

In yet another example, a traveling axle trailer is supported on a ground surface for use in connection with a towing vehicle having a fifth wheel coupling device. The trailer includes a forward deck coupled to the fifth wheel coupling device of the towing vehicle by a hitching assembly. An elongated main deck is pivotally joined to the forward deck, the elongated main deck having a front end and rear end. A lifting device is provided between the forward deck and the elongated deck for enabling movement between the forward deck and the elongated main deck. An undercarriage supports the elongated main deck, the undercarriage including a set of ground engaging wheels. The hitching assembly includes a separable kingpin plate assembly for permitting pivoted movement between the forward deck and the fifth wheel coupling device during the loading operation of the trailer. The plate assembly has a rigid plate constructed with a kingpin depending therefrom for engagement with the fifth wheel coupling device. The forward deck has a forward end pivotally coupled to the rigid plate, and a rearward end provided with at least one stationary locking member. The plate assembly further has a latching assembly mounted on the rigid plate and constructed with a latching member biased normally by a spring force into engagement with the locking member to retain the plate in a locked position relative to the forward deck. Application of a force on the forward deck in excess of the spring force applied on the locking member causes disengagement between the latching member and the locking member enabling the forward deck to separate from the rigid plate thereby permitting, an angle between the elongated main deck and the ground surface to increase during the loading operation.

### BRIEF DESCRIPTION OF THE DRAWINGS

FIG. 1 is a side view of a traveling axle trailer hitched to a towing vehicle and is shown at an advanced tilted loading position with a rear end of a trailer main deck engaging, a ground surface;

FIG. 2 is a top perspective view of the trailer removed from the towing vehicle and shown in a transport position with the trailer main deck raised from the ground surface and partially broken away to illustrate structural elements of the trailer;

FIG. 3 is a bottom perspective view of the trailer shown in FIG. 2 illustrating a wheeled undercarriage mounted at a rear portion thereof;

FIG. 4a is an enlarged fragmentary bottom perspective view of the rear portion of the trailer shown in FIG. 3;

FIG. 4b is an enlarged fragmentary detail view illustrating a rear mounting of the undercarriage from a frame of the trailer;

FIG. 4c is an enlarged fragmentary detail view illustrating a front mounting of the undercarriage from the frame of the trailer;

FIG. 5 is a top perspective view of the wheeled undercarriage isolated away from the of trailer shown in FIG. 4;

FIG. 6 is an enlarged fragmentary bottom perspective view of the trailer extending forwardly from the wheeled undercarriage as shown in FIG. 3;

FIG. 7 is a fragmentary bottom view of the trailer shown in FIG. 3;

FIG. 8 is a view similar to FIG. 7 showing the wheeled undercarriage moved forwardly beneath the main deck;

FIG. 9 is enlarged fragmentary bottom perspective view of the trailer illustrating a forward deck provided with a separable kingpin plate and coupled to a front end of the main deck;

FIG. 10 is a top perspective view of the separable kingpin plate shown in FIG. 9;

FIG. 11 is a sectional view taken on line II-II of FIG. 9 showing the forward deck engaged with the kingpin plate;

FIG. 12 is a view similar to FIG. 11 showing the forward deck disengaged from the kingpin plate;

FIG. 13 is an enlarged perspective view of a warning light mounted on a side of the trailer;

FIG. 14 is an enlarged perspective view of a pivotable access step mounted on the side of the trailer at a forward portion thereof;

FIG. 14A is an enlarged detail view of the pivotable access step taken on line 14A 14A of FIG. 14;

FIG. 15 is an enlarged fragmentary bottom perspective view of a ground engaging bumper assembly at the rear end of the trailer;

FIG. 16A is an enlarged fragmentary side view of the rear end of the trailer in the transport position;

FIG. 16B is a view similar to FIG. 16A showing the rear end of the trailer in a ground engaging loading position;

FIG. 17 is a side view of the trailer in the transport position with the towing vehicle removed for clarity;

FIG. 18 is a side view of the trailer shown own in an initial tilted loaded position with the towing vehicle removed; and

FIG. 19 is a side view of the trailer shown in the advanced tilted loading position with the towing vehicle removed for clarity.

### DETAILED DESCRIPTION

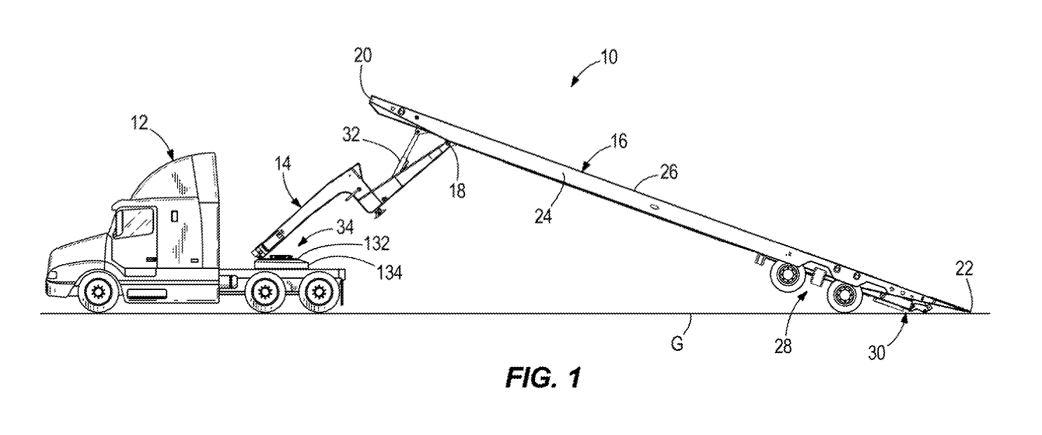

Referring now to the drawings, a traveling axle trailer 10 is shown in an advanced tilted loading position in FIG. 1 coupled behind a towing vehicle 12. The trailer 10 includes a forward goose-neck shaped deck 14 hitched to the towing vehicle 12, and an elongated flat main deck 16 having a front portion which is movably attached at pivot point 18 to the forward deck 14. The main deck 16 has a front end 20, a rear end 22 and an underlying deck supporting frame 24, and defines a tiltable, floor-like bed 26 used in loading and unloading generally heavy goods.

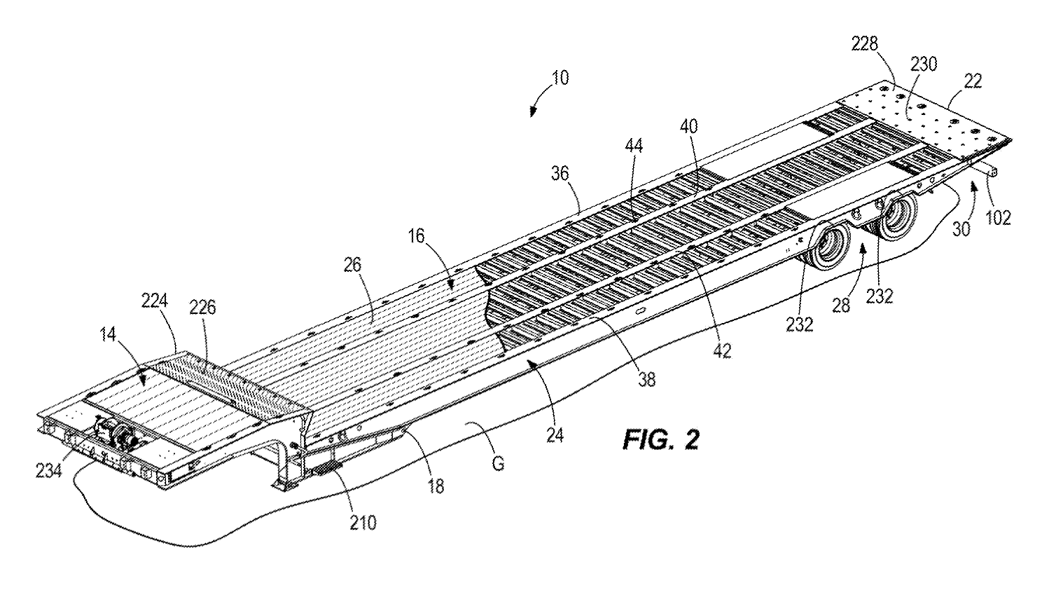

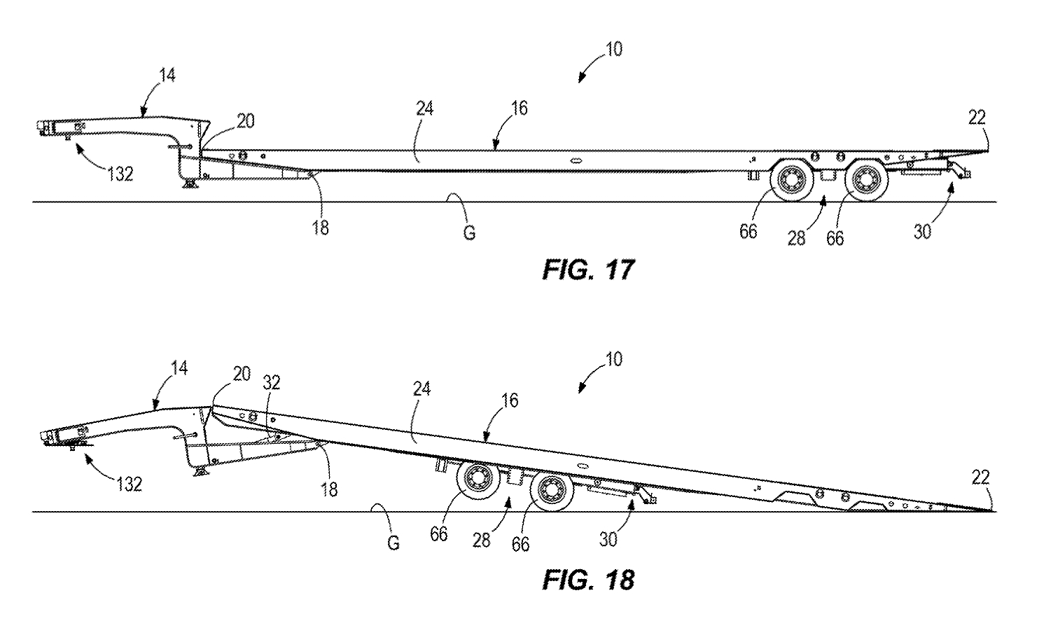

The main deck 16 is provided with a wheeled undercarriage 28 positioned adjacent the rear end 22 thereof on which the trailer 10 is supported for transportation. The undercarriage 28 includes a ground engaging bumper assembly 30, and is shiftably mounted for selective fore and aft travel beneath the main deck 16. As will be appreciated hereafter, the main deck 16 and the undercarriage 28 are movable between various loading positions, and a road traveling transport position, such as is shown in FIGS. 2 and 17, wherein the plane of the main deck 16 is substantially parallel to the ground plane.

A lifting device, such as a fluid pressurized cylinder arrangement 32, is provided between a rear portion of the forward deck 14 and the front portion of the main deck 16. Actuation of the cylinder 32 causes the main deck 16 to pivot relative to the forward deck 14 at the pivot point 18 so that the rear end 22 of the main deck 16 is pivoted towards the ground G. A hitch assembly 34 between the towing vehicle 12 and the forward deck 14 is provided for permitting the forward deck 14 to be tilted relative to the towing vehicle 12 to vary the angle between the main deck 16 and the ground G during loading and unloading of the trailer 10.

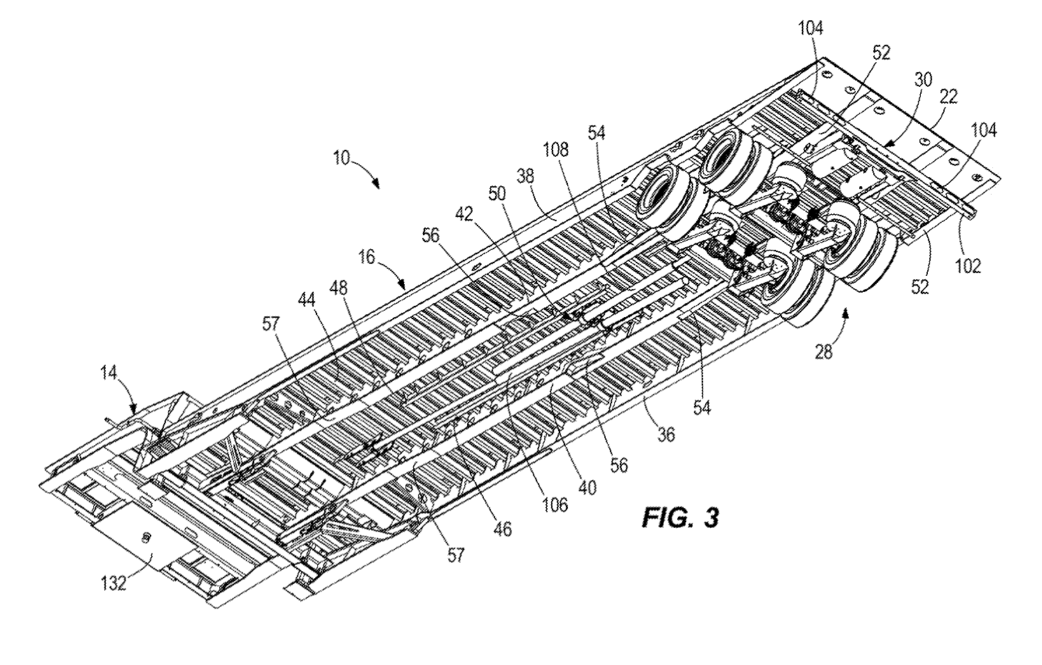

As seen in FIGS. 2 and 3, the frame 24 of the main deck 16 includes a pair of parallel, elongated support beams 36, 38 extending longitudinally of the trailer 10 along the lateral sides thereof A pair of longitudinally extending centrally located guide I-beams 40, 42 are positioned between the main support beams 36, 38, and are configured for movably mounting and guiding the undercarriage 28 thereon. A number of transversely extending crossbeams 44 pass through the guide I-beams 40, 42 and extend between the main support beams 36, 38 for providing structural reinforcement of a mounting structure beneath the main deck 16. As further shown in FIG. 3, the frame 24 further includes a pair of parallel guide channels 46, 48 fixed to the crossbeams 44 and extending longitudinally between the guide I-beams 40, 42. The guide channels 46, 48 serve to slidably guide an undercarriage translating arrangement 50 which is used to selectively shift the undercarriage 28 along the guide I-beams 40, 42 as will be detailed below.

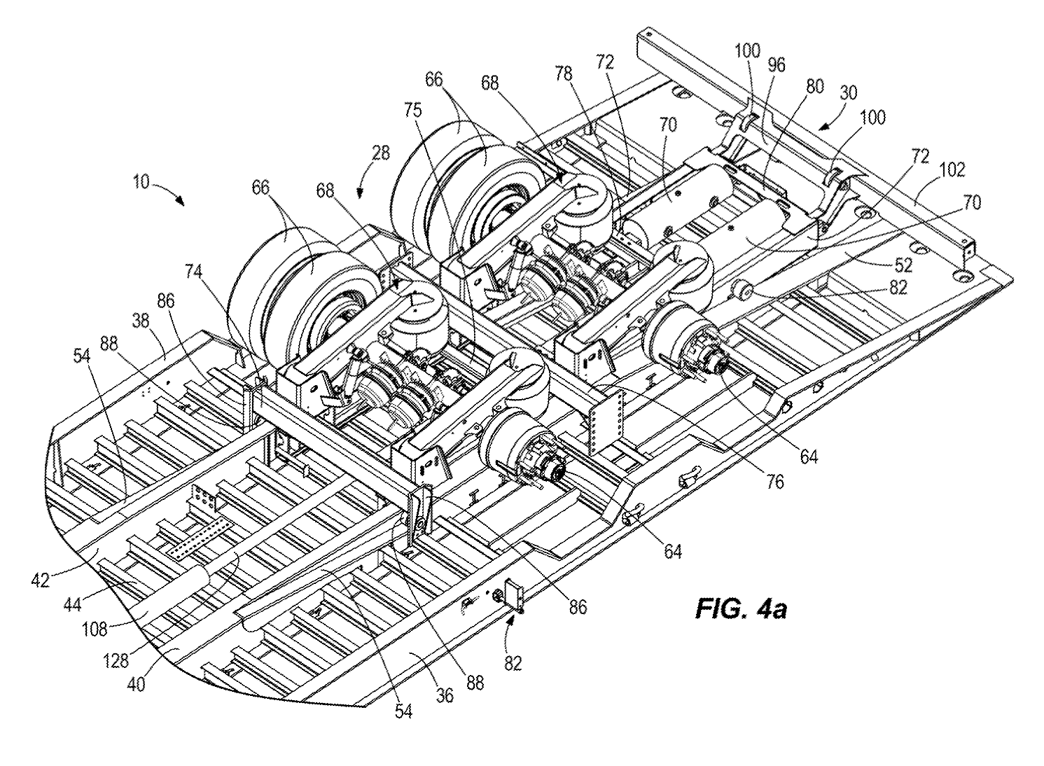

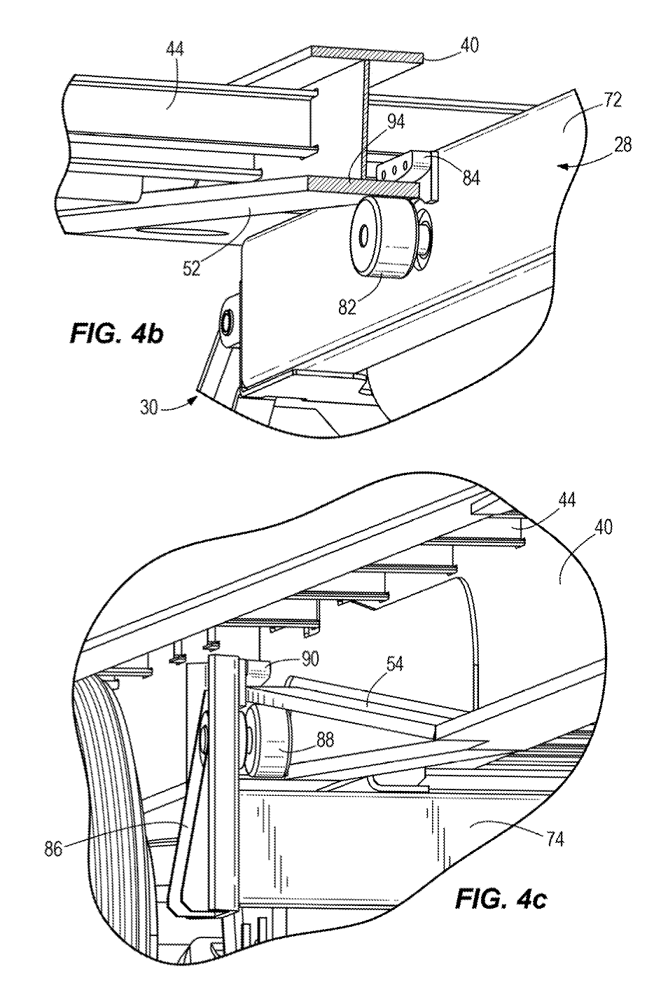

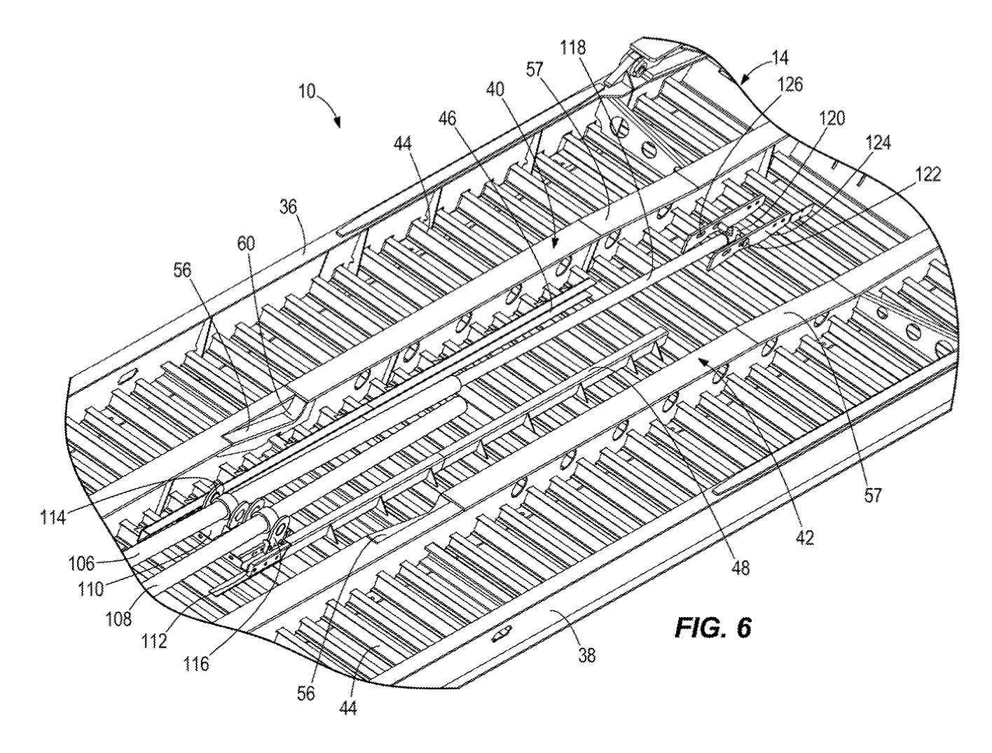

Referring to FIGS. 3, 4a and 6-8, lower surfaces of the guide I-beams 40, 42 are formed with sloping rear surfaces 52, first ramps 54, second ramps 56 and front sloping surfaces 57. As seen in FIG. 4a, sloping surfaces 52 and first ramps 54 extend upwardly and forwardly. As seen in FIG. 6, ramps 56 and sloping surfaces 57 extend downwardly and forwardly. As best seen in FIGS. 6-8, the first ramps 54 terminate in rear docking stations 58 and the second ramps 56 terminate in front docking stations 60. The rear and front docking stations 58, 60, respectively, are designed to establish fore and aft travel limits for the undercarriage 28.

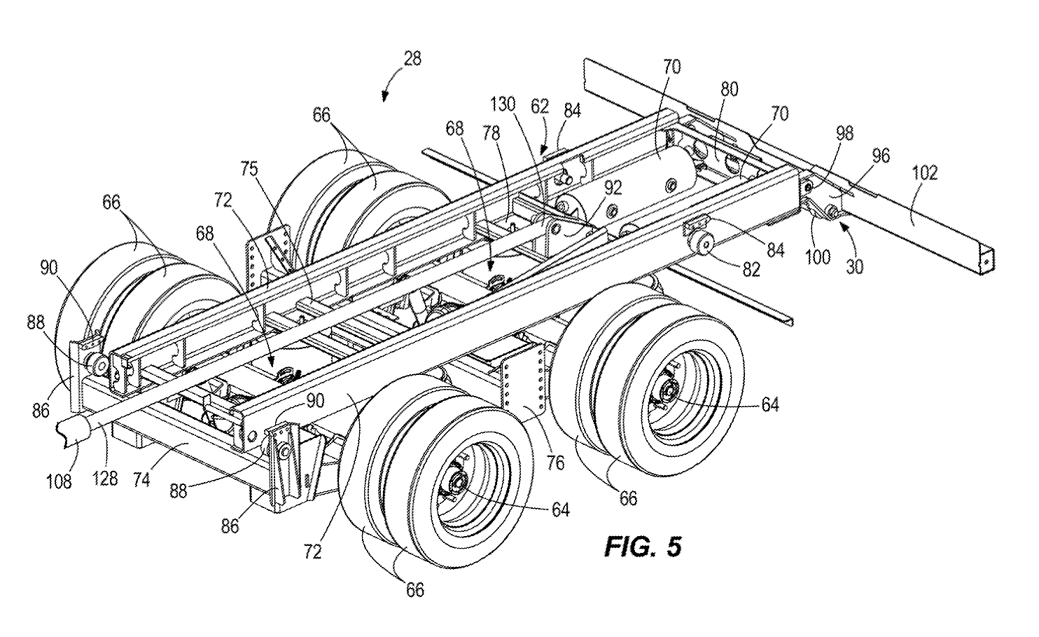

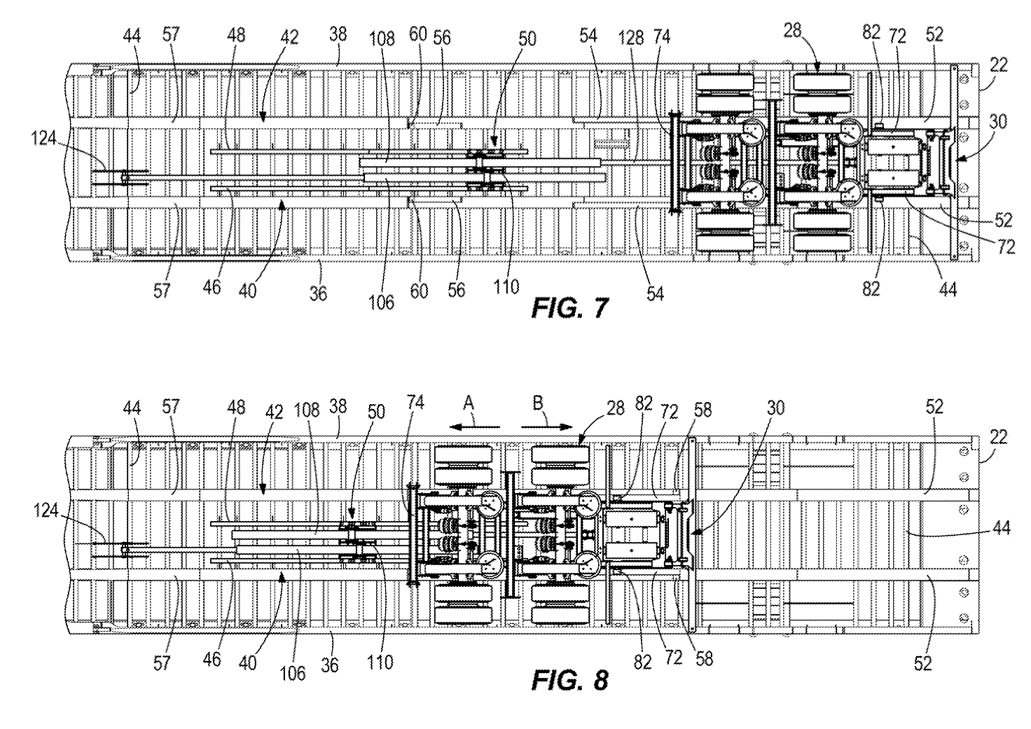

The undercarriage of the trailer 10 is designed to move beneath the main deck 16 in opposite directions as represented by arrows A and B in FIG. 8. The construction of the undercarriage 28 is best shown in FIG. 5 and takes the form of a bogie assembly having a frame 62 on which two axles 64 supporting sets of rotatable ground engaging wheels 66 are mounted, and are provided with cushioning air suspension assemblies 68 in communication with air tanks 70. The frame 62 is designed to receive and retain the axles 64 and mount the suspension assemblies 68 at a low position which contributes in providing a low height for the main deck 16 when the undercarriage 28 is installed therebeneath. The undercarriage frame 62 includes a pair of parallel longitudinally extending side members 72 disposed laterally inwardly of the wheels 66 and joined together by several transverse members, namely, a front cross member 74, intermediate cross members 75, 76, 78 and a rear cross member 80, as seen in FIGS. 4a and 5. Cross members 75 and 78 are designed as low profile mounting surfaces for the suspension assemblies 68. Tanks 70 are mounted between cross members 78 and 80 and provide a source of air for the suspension assemblies 68. The side members 72 of the undercarriage frame 62 are provided with a pair of rotatable rear cam follower rollers 82, both of which are seen in FIGS. 7 and 8. A pair of rear mounting blocks 84 is fixed to the side members 72 above the rear cam follower rollers 82 as seen in FIG. 5. At the front of the frame 62, the transverse cross member 74 has opposite ends provided with support brackets 86 having a pair of front cam follower rollers 88 rotatably secured thereto and a pair of front mounting blocks 90 fixed thereon. The rear cam follower rollers 82 are positioned on the frame 62 inwardly of and between the front cam follower rollers 88. An attachment bracket 92 is connected to the undercarriage cross member 78, and defines a rear mounting bracket for the undercarriage translating arrangement 50 to be further described hereafter.

As seen in FIGS. 4a, 4b and 4c, the rear cam follower rollers 82 of the undercarriage 28 are designed to rollably engage the bottom surfaces of lower flanges 94 of the guide I-beams 40, 42 along inner paths thereon, such as exemplified at each sloping surface 52 (FIG. 4b). The rear mounting blocks 84 are adapted to slidably contact the top surfaces of the lower flanges 94. The front cam follower rollers 88 of the undercarriage 28 are also designed to rotatably engage the bottoms of the lower flanges 94 along outer paths thereon, such as shown along each rear ramp 54 (FIG. 4c), The front cam follower rollers 88 are also designed to roll upon the front sloping surfaces 57 when the undercarriage 28 is moved to a forwardmost position. The front mounting blocks 90 are adapted to slidably contact the top surfaces of the lower flanges 94, one surface engaging portion being shown on top of the rear ramp 54. It should be appreciated that the undercarriage 28 is therefore slidably supported and retained from the guide I-beams 40, 42 of the trailer main frame 24 by means of the mounting blocks 84, 90 so as to prevent the undercarriage 28 from separating from the trailer frame 24. In addition, the undercarriage 28 is rollably mounted on inner and outer paths of the guide I-beams 40, 42 for fore and aft movement relative to the trailer main frame 24 by means of the cam rollers 82, 88.

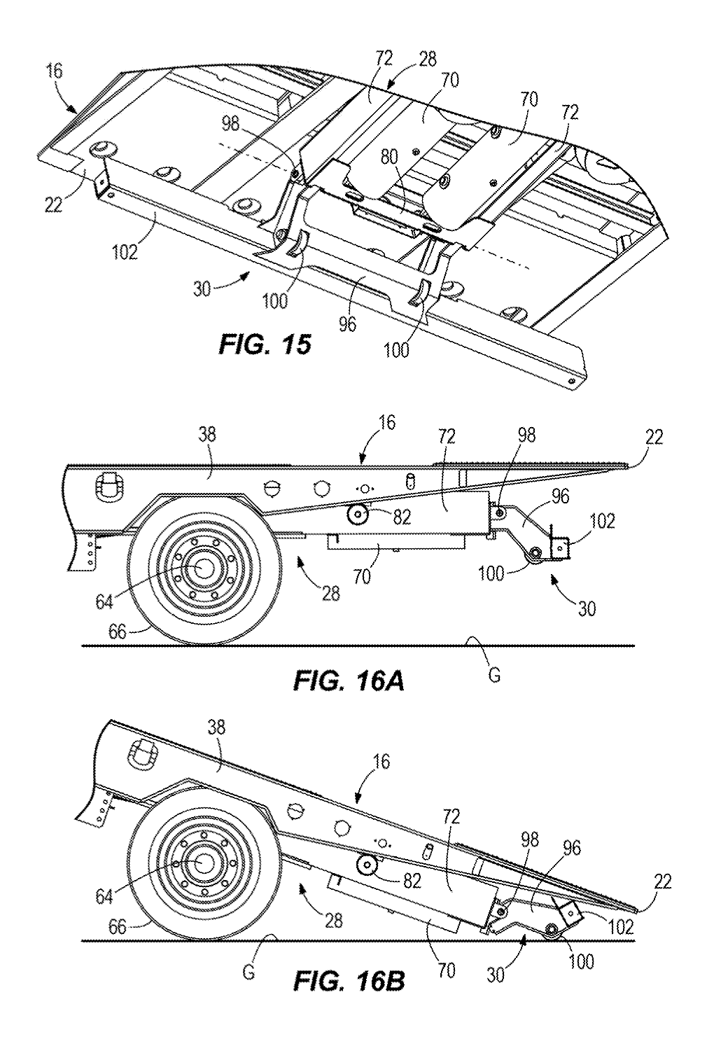

Referring to FIGS. 4a, 5, 15, 16A, 16B, the rear portion of the undercarriage 28 is constructed with the bumper assembly 30 which is used to protect the ground surface G during a loading operation. The bumper assembly 30 includes an outwardly and downwardly extending support arm 86 which is pivotally attached by pins 90 to the rearmost undercarriage cross member 80 such that the bumper assembly 30 may be easily installed, removed and replaced on the undercarriage 28. A pair of rollers 100 having ground engaging portions are rotatably mounted within the support arm 96, and protrude through suitable openings formed therethrough. The support arm 96 is configured to fixedly support a bumper bar 102 which extends transversely across the rear end 22 of the trailer 10. As seen in FIG. 3, the bumper bar 102 is typically provided with a series of rearwardly facing lights 104, such as it opposite ends.

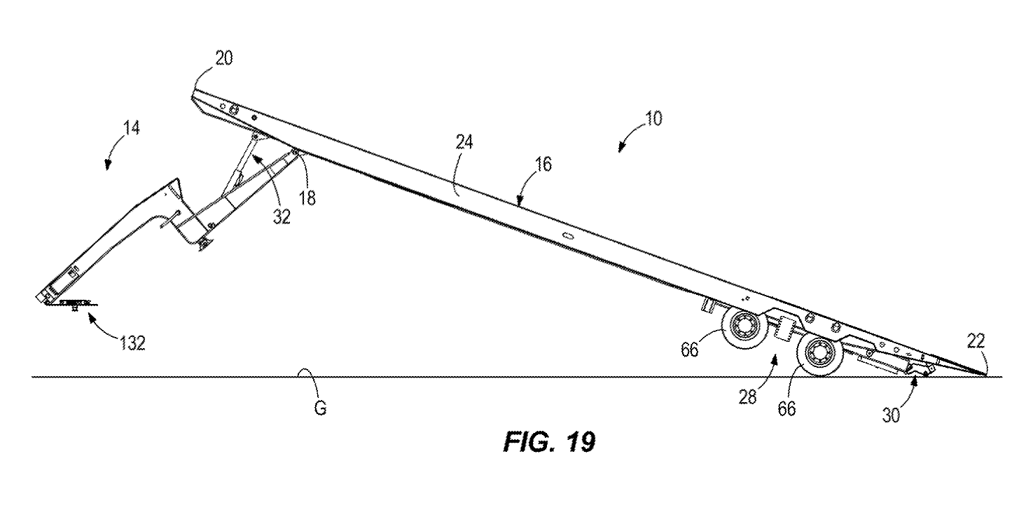

When in the transport position, the bumper assembly 30 is designed to be carried in the position shown in FIG. 16A spaced beneath the rear end of the trailer 10. When the trailer 10 is adjusted to its maximum tilted loading position, as depicted in 16B as well as in FIGS. 1 and 19, the support arm 96 is pivoted about the pins 98 so that the rollers 100 softly touch down on the ground G, blacktop, concrete or other loading surface thus causing minimal damage thereto. When the trailer 10 again assumes the transport position, the bumper assembly 30 will pivot by gravity hack to its position shown in FIG. 16A.

The undercarriage translating arrangement 50 is utilized to move or shift the undercarriage 28 between the transport position shown in FIG. 17 and the loading positions shown in FIGS. 18 and 19, The translating arrangement 50 is illustrated in FIGS. 3 and 6-8 and includes a master hydraulic cylinder 106 and a slave hydraulic cylinder 108 operably connected such as by hydraulic, lines, in side-by-side relationship. The hydraulic cylinder 106 is positioned such that its longitudinal axis is slightly off center relative to the longitudinal axis of the main frame 24 so as to provide clearance when the undercarriage 28 is moving. As most clearly seen in FIG. 6, the hydraulic cylinder 106, 108 are arranged for sliding movement on an adjustable anchorage formed by a carriage 110 which is slidably mounted for back and forth movement within the mounting channels 46, 48. In one exemplary embodiment, side edges of the carriage 110 are slidably mounted along bearing pads 112 fixed longitudinally within the channels 46, 48, but it should be understood that other suitable sliding structure may be provided between the carriage 110 and the mounting channels 46, 48.

A first mounting bracket 114 is engaged with the master hydraulic cylinder 106 and is adjustably secured on the carriage 110. A second mounting bracket 116 is coupled to the slave hydraulic cylinder 108 and is adjustably connected to the carriage 110 independently of the first mounting bracket 114. The mounting brackets 114, 116 provide for an independent servicing of the cylinders 106, 108 when desired. The master cylinder 106 includes forwardly extending piston rod 118 having a rod end 120 joined by a retaining pin 122 to a forward mounting bracket 124 fixed to the cross members 44 beneath the forward portion of the trailer 10. The forward mounting bracket 124 is provided with various holes 126 facilitating an adjustable mounting of the rod end 120. The slave cylinder 108 has a rearwardly extending piston rod 128 having rod end 130 fixed to the rear mounting bracket 92 (FIG. 5). The translating arrangement 50 is designed to provide a travelling and adjustable cylinder assembly which allows the cylinders 106, 108 to fit any length of the trailer 10, and to travel along with the undercarriage 28.

The hitching assembly 34 shown in FIG. 1 includes a separable king pin plate assembly 132 for permitting pivoted movement between the forward deck 14 and a fifth wheel coupling device 134 of the towing vehicle 12.

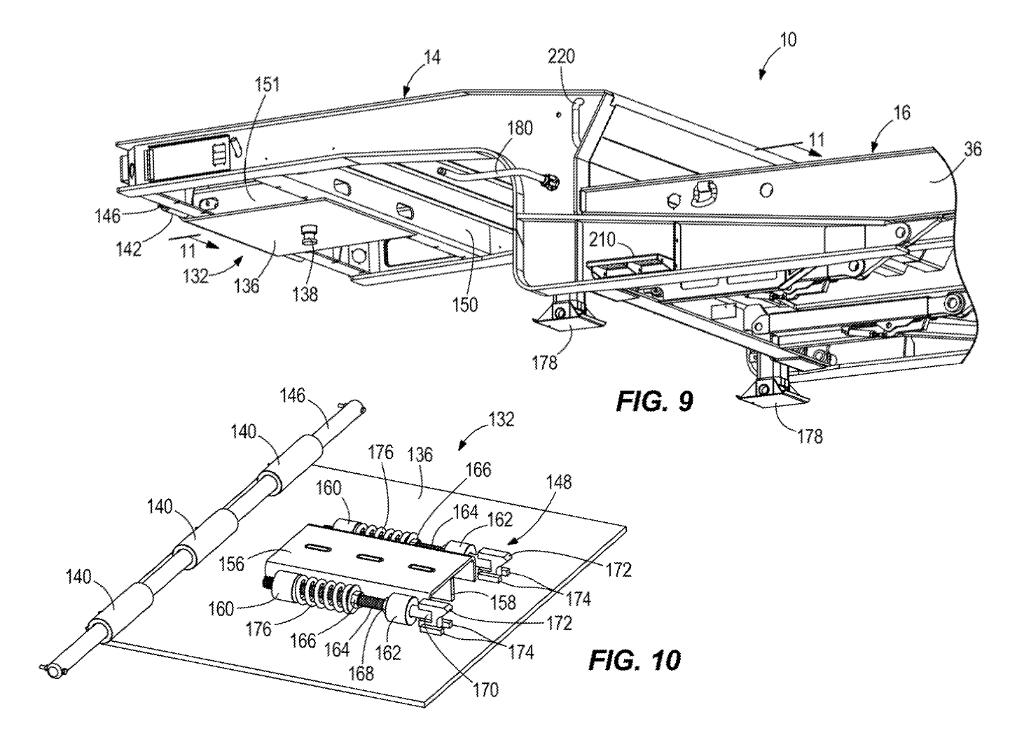

Details of the king pin plate assembly 132 are illustrated in FIGS. 9-12. The plate assembly 132 includes a rigid locking plate 136 having a king pin 138 welded or otherwise fixed from a lower surface of the plate 136 for engagement with the fifth wheel device 134 of the towing vehicle 12 as is well known. A front end of the plate 136 also includes a set of spaced apart hinge barrels 140 which are aligned with similar barrels (one being seen at 142 and in FIGS. 9, 11 and 12) joined to a front crossbeam 144 extending across a front end of the forward deck 14. The aligned barrels 140, 142 receive a rod 146 positioned at the bottom front end of the forward deck 14 so that a pivotal connection is established between the forward deck 14 and the plate 136.

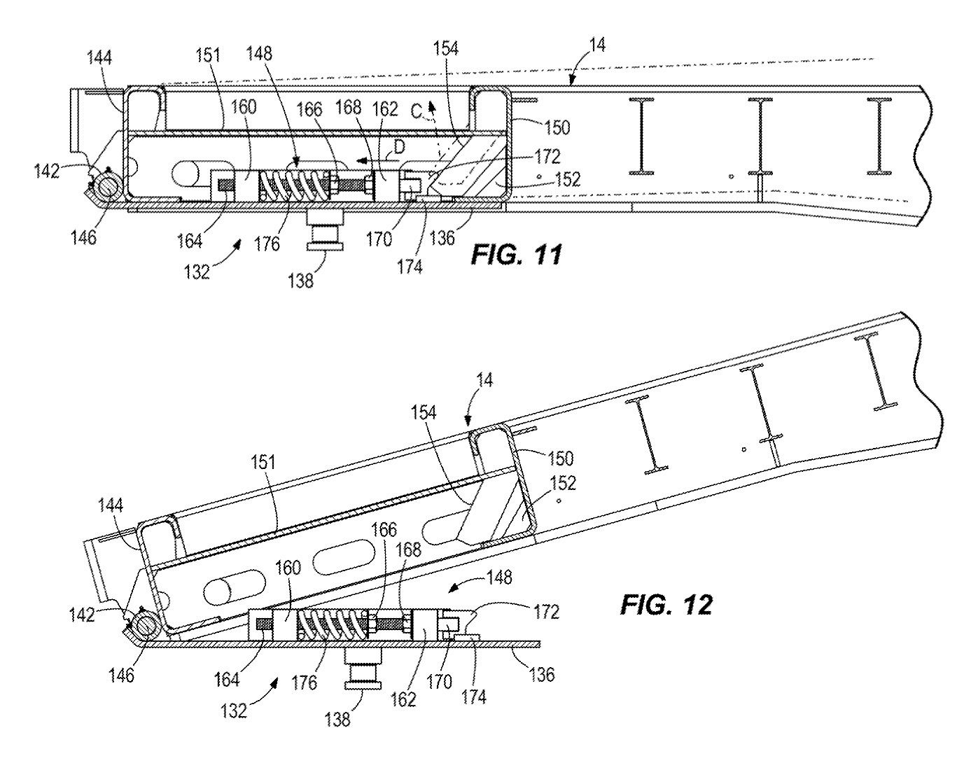

A double spring biased latching assembly 148 is provided on the plate 136 for providing retention and release of the plate 136 and the king pin 138 relative to a rear crossbeam 150 of the forward deck 14 extending transversely beneath an upper surface thereof. The crossbeam 150 is joined to a pair of longitudinal members extending forwardly to the front crossbeam 144 of the forward deck 14, one longitudinal member being shown at 151. As depicted in FIGS. 11 and 12, the crossbeam 150 is provided with at least one stationary locking tab 152 having an angled engagement surface 154.

The latching assembly 148 includes a channel 156 and a reinforcing gusset 158 fixed to the top of the plate 136. On each side of the channel 156, two spaced apart bosses 160, 162 are welded to the plate 136, and configured to receive a threaded locking pin 164 provided with a pair of nuts 166, 168 threaded thereon. The locking pin 164 has an unthreaded end 170 which is retained within a latching angled nose member 172 positioned between a pair of guide blocks 174 fixed to the plate 136 for guiding travel of the nose member 172 relative to the plate 136. A coil spring 176 is disposed between the boss 160 and the nut 166 and, with suitable positioning of the nuts 166, 168, provides an adjustable biasing force on the locking pin 164 so that the nose member 172 is normally forced into locking engagement with the angled engagement surface 154 of locking tab 152 on the forward deck crossbeam 150. Thus, it should be appreciated that the dual springs 176 hold the nose members 172 engaged adjacent the locking tab 152 with a positive force that will retain the plate 136 in locked position shown in FIG. 11 during a normal transport condition of the trailer 10.

However, in the event an upward force is applied in the direction of arrow C (FIG. 11) to move the forward deck 14 to the dotted line position, the nose members 172 are forced in the direction of arrow D against the biasing force of springs 176. As can be seen in FIG. 12, further upward movement of the forward deck 14, such as experienced during a loading operation, will cause the forward deck 14 to pivot about the axis of rod 146 and attain the unlocked position in which the locking tab 152 and the forward deck 14 separate and break away from the plate 136 leaving the king pin 138 connected to the fifth wheel coupling device 134. The plate assembly 132 thus permits tilting of the forward deck 14 relative to the towing vehicle 12 to increase the angle between the main deck 16 and the ground surface during loading and unloading operations.

As can also be seen in FIG. 9, the front deck 14 is provided with a pair of extendable and retractable support legs 178 which can be lowered from a raised position to a wound engaging lowered position by using a rotatable handle 180 to support the trailer 10 in a transport position when the towing vehicle 12 is uncoupled from the trailer 10.

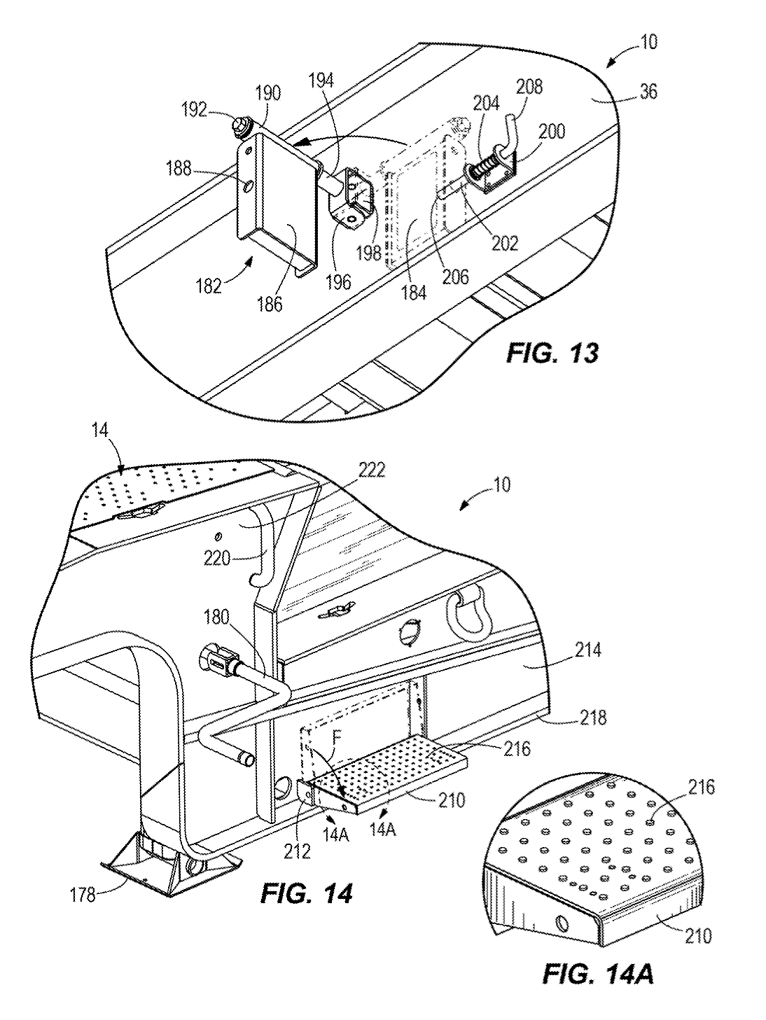

The trailer 10 is designed with a set of strobe warning lights assemblies mounted externally on the rear portions of the main support beams 36, 38, and activated when the main deck 16 is in any tilted position to illuminate the rear of the trailer 10. One such warning, light assembly 182 is depicted on support beam 36 in FIG. 4a, and is illustrated in FIG. 13 swingably mounted from a retained storage position (shown in dotted lines), such as used during trailer transport, to a released operating position (shown in solid lines), such as used during trailer loading and unloading.

The warning light assembly 182 includes a strobe light 184 (as seen in the storage position) mounted on a light holder 186 formed in a sidewall thereof with an aperture 188. A tube 190 is fixed to a top of the light holder 186, and receives the shaft of a bolt 192 extending therethrough so that the light 184, light holder 186 and the tube 190 are freely swingable about the bolt 192 and are designed to continuously hang downwardly, such that an illuminated beam of the light 184 shines rearwardly and parallel to the ground surface regardless of the tilted position of the trailer 10. The light holder 186 is connected by a tube extension 194 to a first mounting bracket 196 pivotally mounted about a vertical axis to a second mounting bracket 198 fixed to the support beam 36. The mounting brackets 196, 198 are constructed to limit the travel of the light 184 and the holder 186 to the solid line position of FIG. 13 such that the pivot axis of bolt 192 is generally perpendicular to the support beam 36. A third mounting bracket 200 is secured to the support beam 36, and is used to slidably mount a locking pin 202 which is surrounded by a spring 204 retained within bracket 200 to provide a biasing force on the pin 202 which will normally cause an engagement end 206 of the pin 202 to protrude in the direction of the mounting brackets 196, 198. The pin 202 is formed with a handle portion 208 which can be used to retract the engagement end 206 of the pin 202 against the biasing force of spring 204 to release the light holder 186.

In the storage position, the light 184 and the light holder 186 are positioned against the support beam 36 with the light 184 facing outwardly therefrom, and the engagement end 206 of the pin 202 is inserted within the aperture 188 to prevent movement of the light holder 186. When it is desired to use the warning light assembly 182, the pin 202 is retracted from the aperture 188, and the light holder 186 is swung outwardly in the direction of arrow F where suitable locking structure, such as cooperating detents or other suitable structure, on the mounting brackets 194, 196 hold the light 184 and the light holder 186 in the operating position at which the light 184 can be suitably illuminated. if desired, a counterweight may be provided within the light holder 186 to facilitate the desired downward disposition thereof

As seen in FIGS. 14 and 14A, a foldable access step 210 is provided at the forward end of the trailer 10 to enable trailer personnel to easily gain access to the forward deck 14 and the main deck 16 when the trailer 10 is in the transport position. The access step 210 is pivotally mounted about a suitable mounting structure 212 secured on a lower side portion 214 of the goose necked forward deck 14, and is constructed with a anti-slip surface 216. The access step 210 is movable in a direction of arrow F between an upright storage position (shown in dotted lines) engaged against a side surface of the lower portion 214, and a lowered operating position (shown in solid lines) engaged against and supported by a ledge 218 on the lower portion 214. Although not illustrated, the access step 210 may be retained in and released from the storage position using a spring biased locking pin arrangement, as similarly described in conjunction with the light assembly 182. A grab handle 220 is mounted on an upper side portion 222 of the forward deck 14, and can be used in conjunction with the step 210.

In addition to the access step 210, a rearward ramp portion 224 (FIG. 2) of the forward deck 14 is provided with an anti-slip surface 226, and a rear lead up plate 228 adjacent the trailer rear end 22 is also constructed with an anti-slip surface 230. Wheel arches 232 of the trailer 10 can also be provided with anti-slip surfaces.

In an exemplary embodiment, the anti-slip surfaces can be formed by stamping upwardly projecting protrusions in the metal plates used in the step 210, the ramp portion 224 and the plate 228. The protrusions have closed, top surfaces and are preferably shaped with round edges, typically sized up to 3 inches in diameter, and arranged in any desired pattern.

Although not illustrated, it should be understood that the trailer 10 is suitably provided with a hydraulic source of power, a hydraulic circuit and hydraulic controls for controlling the hydraulic cylinders 32, 106, and 108. It should also be understood that the trailer 10 can be equipped with trailer brakes independent of brakes provided on the towing vehicle 12.

One example of a loading operation of the trailer 10 is described as follows. Normally, when the trailer 10 is parked on a flat ground surface in the transport position, as shown in FIG. 17, the main deck 16 has a lower deck height which permits the trailer 10 to be used in transporting tall objects without violating state and federal height restrictions. The low height of the main deck 16 is minimized by the compact profile of the undercarriage 28 and its moveable mounting on the particularly configured guide I-beams 40, 42, as described above.

In the transport position shown in FIG. 17, the brakes of the towing vehicle 12 have been applied and the drive wheels of the towing vehicle 12 appropriately secured by chocks. The undercarriage 28 is in its rearmost position and the rear end 22 of the trailer 10 is elevated from the ground G. As seen in FIGS. 4a and 7, with the undercarriage 28 in the rearmost position, the rear cam follower rollers 82 are positioned upon the sloping surfaces 52 of the guide I-beams 40, 42 and the front cam follower rollers 88 are positioned in the rear docking stations 58 of the guide I-beams 40, 42.

When it is desired to initiate a tilted loading operation, the operator activates the hydraulic circuit to start moving the undercarriage 28 forwardly beneath the main deck 16 from the rearmost position as depicted in FIG. 18. More specifically, the cylinders 106, 108 of the translating arrangement 50 are energized so that the rear cam followers 82 move upwardly along inner paths on the sloping surface 52 and then onto flat surfaces of the guide I-beams 40, 42 as seen in FIG. 4a. The from cam follower rollers 88 move upwardly along outer paths on ramps 54 in the direction of arrow A in FIG. 8 and then onto flat suffices of the guide I-beams 40, 42. At the same time, the operator actuates the lifting device 32 causing the front end 20 of the main deck 16 to be raised relative to the lower portion of the forward deck 14 and forcing the upper portion of the forward deck 14 to separate from the king, pin plate assembly 132. The combined initial movement of the undercarriage 28, the front end. 20 and the forward deck 14 results in tilting the main deck 16 to an initial loading position so that the rear end 22 thereof moves into initial contact with the ground G as shown in FIG. 18.

At this point, the angle between the main deck 16 and the ground G can be increased by continuing to wove the undercarriage 28 forwardly beyond the position shown in FIG. 18 as the front end 20 and the forward deck 14 are further raised. During this movement, the rear cam follower rollers 82 are moved on inner paths along flat surfaces of the guide I-beams 40, 42 until the rear rollers 82 reach the forward docking stations 60. The front cam follower rollers 88 continue to ride along outer paths on forward flat portions of the guide I-beams 40, 42 and onto downwardly sloping ramps 57 formed thereon.

Once the main deck 16 has been tilted to the loading position shown in FIG. 19, the undercarriage 28 is moved backwards via the cylinders 106, 108 to its rearward position during which the support arm 96 on the bumper assembly 30 pivots beneath the trailer rear end 22 so that the rollers 100 contact the ground G to protect the rear end 22 from gouging and damaging the ground G or other loading surface. In addition, the movement of the bumper assembly 30 causes the bumper bar 102 to pivot upwardly so that the bar 102 is prevented from being damaged.

During the movement of the trailer 10 to its various loading positions, the rear wheels 66 are held in continuous engagement with the ground G. It should be understood that the hydraulic cylinders 32, 106 and 108 may be controlled as desired by the operator to attain the desired angle of the main deck 16 relative to the ground during loading.

Once the trailer 10 has reached a desired loading position, heavy objects can be loaded onto the rear end 22 of the main deck by suitably positioning the main deck 16 as previously described. In some instances, it is helpful to employ a winch 234 (FIG. 2) such as mounted at the forward deck 14 to facilitate loading. Once a loading operation is finished and the loaded objects are secured, the undercarriage 28 is shifted and the main deck 16 of the trailer 10 is moved to the transport position shown in FIG. 17 using the cylinders 106, 108 and the lifting device 32 until the king pin plate assembly 132 reengages with the forward deck 14. Thereafter, the loaded trailer 10 can he pulled by the towing vehicle 12 to its desired destination.

While the preferred embodiments of the invention have been shown and described, it will apparent to those skilled in the area that changes and modifications may be made without departing from the spirit of the invention.

What is claimed is:

1. A traveling axle trailer movable between a transport position and a loading position, the trailer comprising:
an elongated deck adapted to be connected to a towing vehicle, the elongated deck being constructed with a front end, a rear end and an underlying main frame provided with a pair of main support beams extending longitudinally of the trailer along lateral sides thereof, and a pair of guide beams extending longitudinally of the trailer between the main support beams, the main frame including a set of transverse crossbeams interconnecting the main support beams and the guide beams;
an undercarriage movably supported and guided along the guide beams between the transport position and the loading position; and
a translating arrangement for moving the undercarriage back and forth along the guide beams,
wherein the undercarriage includes an undercarriage frame having a plurality of axles provided with ground engaging wheels mounted thereon, the frame including a pair of longitudinal side members disposed laterally inwardly of the heels and joined together by a front cross member and a rear cross member, the front cross member including a set of front guiding and supporting assemblies located outside the side members of the undercarriage frame and engaged with the guide beams, the side members having outer surfaces including a set of rear guiding and supporting assemblies engaged with the guide beams and spaced forwardly of the rear cross member.

2. The trailer of claim 1, wherein the undercaniage frame further includes intermediate cross members joined between the side members and defining mounting surfaces for suspension assemblies provided on the axles inwardly of the side members of the undercarriage frame.

3. The trailer of claim 2, wherein the suspension assemblies are connected with a tank structure mounted between one of the intermediate cross members and the rear cross member.

4. The trailer of claim 1, wherein the undercarriage frame is constructed with a pivotable bumper assembly extending rearwardly from the rear cross member.

5. The trailer of claim 4, wherein the bumper assembly includes a support arm having one end pivotally connected to the rear cross member, and another end fixed to a bumper bar positioned beneath the rear end of the elongated deck such that the bumper bar is movable relative to the rear end.

6. The trailer of claim 5, wherein the support arm is provided with a set of rollers adapted to engage the ground surface for preventing damage to the rear end of the trailer when the trailer is moved from the transport position to the loading position.

7. The trailer of claim 1, wherein at least one warning light assembly is swingably mounted to one of the main support beams of the main frame between a locked storage position against the support beam and a released operating position away from the support beam in which the warning light assembly continuously hangs downwardly regardless of the loading positions of the trailer.

8. The trailer of claim 7, wherein the warning light assembly includes a strobe light mounted on a light holder, the strobe light on the light holder being connected to a tube swingably mounted on a bolt extending from a first mounting assembly joined to the main support beam.

9. The trailer of claim 8, wherein in the warning light assembly further includes a spring biased locking pin arrangement which is selectively engaged and disengaged with the light holder.

10. The trailer of claim 1, wherein a rear portion of the elongated main deck is provided with an anti-slip surface having upwardly projecting protrusions.

11. A traveling axle trailer supported on a ground surface and movable from a transport position to a loading position, the trailer comprising:
an elongated deck adapted to be connected to a towing vehicle, the elongated deck being constructed with a front end, rear end, and an underlying main frame provided with a set of main support beams extending longitudinally of the trailer along lateral sides thereof, and a pair of guide beams extending longitudinally of the trailer between the main support beams, the main frame including a set of transverse crossbeams interconnecting the main support beams and the guide beams, the guide beams being configured with rear guiding and supporting, surfaces extending in one sloping direction between the front end and the rear end of the trailer, and front guiding and supporting surfaces located forwardly of the rear guiding and supporting surfaces and extending in another sloping direction opposite the one sloping direction between the front end and the rear end of the trailer;
an undercarriage movably supported and guided along the guide beams of guide beams between the transport position and the loading position, the undercarriage having a frame provided, with a set of front guiding and supporting assemblies and a set of rear guiding and supporting assemblies spaced rewardly of the front guiding and supporting assemblies, the front and rear guiding and supporting assemblies being engaged for progressive movement with the rear guiding and supporting surfaces in the one sloping direction and with the front guiding and supporting surfaces in the oppositely sloping direction to move the elongated deck from the transport position to the loading position during which movement the elongated deck is tilted such that the rear end of the trailer engages the ground surface; and a translating arrangement for moving the undercarriage along the guide beams.

12. The trailer of claim 11, wherein the rear supporting and guiding surfaces are formed as upwardly sloping, surfaces and ramps, and the front supporting and guiding surfaces are formed as downwardly sloping surfaces and ramps.

13. The trailer of claim 11, wherein in the undercarriage includes an undercarriage frame having longitudinal side members connected by at least a front transverse cross member and a rear transverse cross member, and the rear guiding and supporting assemblies are defined by rear cam follower rollers and rear mounting blocks mounted on the side members forwardly of the rear cross member.

14. The trailer of claim 13, wherein the front guiding and supporting assemblies are defined by front cam rollers and front mourning blocks mounted outside the front cross member and the side members.

15. The trailer of claim 11, wherein the translating arrangement is defined by a cylinder arrangement secured on a carriage movably mounted between a pair of parallel guide channels joined to the transverse cross beams of the main frame.

16. The trailer of claim 15, wherein the cylinder arrangement includes a master cylinder having a piston rod adjustably connected to a forward mounting bracket fixed to the transverse cross beams beneath the forward end of the trailer.

17. The trailer of claim 16, wherein the cylinder arrangement further includes a slave cylinder having a piston rod fixed to a rear attachment bracket fixed on the undercarriage frame.

18. The trailer of claim 15, wherein the carriage includes a first mounting bracket engaged with the master cylinder, and a second mounting bracket engaged with the slave cylinder.

19. The trailer of claim 11, wherein a rear portion of the elongated deck is provided with an anti-slip surface.

20. A traveling axle trailer supported on a ground surface for use in connection with a towing vehicle having a fifth wheel coupling device, the trailer comprising:
a forward deck coupled to the fifth wheel coupling device of the towing vehicle by a hitching assembly;
an elongated main deck pivotally joined to the forward deck, the elongated deck having a front end and a rear end;
a lifting device provided between the forward deck and the elongated main deck for enabling movement between the forward deck and the front end of the elongated main deck;
an undercarriage supporting the elongated main deck and shiftably mounted along the main deck, the undercarriage including a set of ground engaging wheels,
wherein the hitching assembly includes a separable king pin plate assembly for permitting a pivoted movement between the forward deck and the fifth wheel coupling device during a loading operation of the trailer, the plate assembly having a rigid plate constructed with a king pin depending therefrom for engagement with the fifth wheel coupling device, the forward deck having a forward end pivotally coupled to the rigid, plate, a rearward end provided with at least one stationary locking member, the plate assembly further having a latching assembly mounted on the rigid plate and constructed with a latching member normally biased by a spring force into engagement with the locking member to retain the plate in a locked position relative to the forward deck,
whereby application of a force on the forward deck in excess of the spring force applied on the locking member causes disengagement between the latching member and the locking member enabling the forward deck to separate from the rigid plate thereby permitting an angle between the elongated main deck and the ground surface to increase during the loading operation.

21. The trailer of claim 20, wherein the latching arrangement includes a channel fixed to the plate, opposite sides of the channel each being provided with a pair of bosses secured to the plate and configured to receive a threaded locking pin provided with a pair of nuts threaded thereon, the locking pin being provided with an unthreaded end retained with the latching member positioned between a pair of guide blocks fixed to the plate for guiding travel of the latching member, a coil spring on each side of the channel being, disposed between the bosses and one of the nuts so that adjusting of the nuts provides an adjustable biasing force on the locking pin and the latching member to retain the latching member in the locked position with the locking member.

22. The trailer of claim 20, wherein the forward deck is provided with an access step pivotally mounted thereon between an upright storage position and a lowered operating position.

23. The trailer of claim 22, wherein the access step is provided with an anti-slip surface having upwardly projecting protrusions.

24. The trailer of claim 20, wherein the front deck is provided with an anti-slip surface having upwardly projecting protrusions.

25. The trailer of claim 20, wherein a rear portion of the elongated main deck is provided with an anti-slip surface having upwardly projecting protrusions.
